(19) United States
(12) Patent Application Publication
(10) Pub. No.: US 2020/0156516 A1
(43) Pub. Date: May 21, 2020

(54) SLEEPER SEAT FOR VEHICLE

(71) Applicant: TACHI-S ENGINEERING U.S.A., INCORPORATED, Farmington Hills, MI (US)

(72) Inventors: Yasuo KAKISHIMA, Farmington Hills, MI (US); Ravi KRISHNAN, Farmington Hills, MI (US); Dwight PRESSER, Farmington Hills, MI (US)

(21) Appl. No.: 16/191,697

(22) Filed: Nov. 15, 2018

(51) Int. Cl. B60N 2/34; B60N 2/12; B60N 2/20; B60N 2/22; A47C 1/024

(52) U.S. Cl. CPC B60N 2/34; B60N 2/12; A47C 1/024; B60N 2/22; B60N 2/20

(57) ABSTRACT

To provide a flat reclining posture that becomes approximately parallel to a floor surface of a vehicle. A vehicle seat includes a seat cushion, a seat back, risers, a reclining mechanism, a first link member, a second link member, and tracks. The seat cushion includes a cushion frame. The seat back includes a back frame. The reclining mechanism is disposed at an upper portion at a rear end of the riser. The reclining mechanism is coupled to a lower end portion of the back frame. The first link member is rotatably disposed between a rear end portion of the cushion frame and the reclining mechanism. The second link member is rotatably disposed between upper portions at front ends of the risers and front end portions of the cushion frame. The tracks are disposed at lower portions of the risers. In conjunction with a rear inclination of the seat cushion by the reclining mechanism, a rear end portion of the seat cushion moves forward and upward by the first link member, and a front end portion of the seat cushion moves forward and upward by the second link member.

### BACKGROUND

The present invention relates to a vehicle seat and is especially applicable to a vehicle seat that can flatten (horizontal state) a seat cushion and a seat back.

There have been proposed techniques of vehicle seats that flatten seat cushions and seat backs (see JP2010-116114A, JP2004-31387A, JP H09-262149A, and JP 563-34253A).

However, it is extremely difficult to provide a flat reclining posture where a surface of a seat cushion and a surface of a seat back are approximately parallel to a floor surface of a vehicle.

An object of the present invention is to provide a flat reclining posture that becomes approximately parallel to a floor surface of a vehicle.

Other objects and novel features will become clear by descriptions in this Description and attached drawings.

### SUMMARY OF THE INVENTION

A brief description of an outline of representative configurations of the present invention is as follows.

That is, a vehicle seat includes a seat cushion, a seat back, risers, a reclining mechanism, a first link member, a second link member, and tracks. The seat cushion includes a cushion frame. The seat back includes a back frame. The reclining mechanism is disposed at an upper portion at a rear end of the riser. The reclining mechanism is coupled to a lower end portion of the back frame. The first link member is rotatably disposed between a rear end portion of the cushion frame and the reclining mechanism. The second link member is rotatably disposed between upper portions at front ends of the risers and front end portions of the cushion frame. The tracks are disposed at lower portions of the risers. In conjunction with a rear inclination of the seat cushion by the reclining mechanism, a rear end portion of the seat cushion moves forward and upward by the first link member, and a front end portion of the seat cushion moves forward and upward by the second link member.

The vehicle seat can provide a flat reclining posture that becomes approximately parallel to a floor surface of a vehicle.

### BRIEF DESCRIPTION OF THE DRAWINGS

FIG. 1 is a side view illustrating a configuration of a vehicle seat according to a first embodiment;

FIG. 2 is a front perspective view illustrating a frame structure of the vehicle seat of FIG. 1;

FIG. 3A is a left side view illustrating a usual use state of the frame structure of the vehicle seat of FIG. 2;

FIG. 3B is a left side view illustrating a state close to a full-flat state of the frame structure of the vehicle seat of FIG. 2;

FIG. 4A is a left side view illustrating the usual use state when a seat skin and a cushion material are attached to the frame structure of FIG. 3A;

FIG. 4B is a left side view illustrating the state close to the full-flat state when the seat skin and the cushion material are attached to the frame structure of FIG. 3B;

FIG. 5 is a drawing describing the usual use state and the full-flat state of the vehicle seat;

FIG. 6 is a side view illustrating a configuration of a vehicle seat according to a second embodiment;

FIG. 7 is a drawing describing a usual use state and a full-flat state of the vehicle seat according to the second embodiment;

FIG. 8 is a side view illustrating a slide mechanism; and

FIG. 9 is a cross-sectional view of the slide mechanism taken along a line A-A in FIG. 8.

### DETAILED DESCRIPTION OF THE PREFERRED EMBODIMENTS

The following describes embodiments of the present invention with reference to the drawings.

Note the disclosure is merely one example, and, for clearer descriptions, the drawings are schematically illustrated in width, thickness, shape, and similar factor of each unit compared with those of actual aspects in some cases. However, they are not intended to limit interpretations of the present invention. In the present description and the respective drawings, components similar to those described previously with reference to earlier figures are labeled with like reference numerals, and the detailed description thereof is omitted appropriately. In the drawings, the FRONT arrow indicates a front of a vehicle, the REAR arrow indicates the rear of the vehicle, the LEFT arrow indicates the left side of the vehicle, the RIGHT arrow indicates the right side of the vehicle, the UP arrow indicates the upper side of the vehicle, and the DOWN arrow indicates the lower side of the vehicle. In the following description, unless otherwise stated, the front, rear, upper, lower, left, and right are intended to mean the front, rear, upper, lower, left, and right of the vehicle.

### First Embodiment

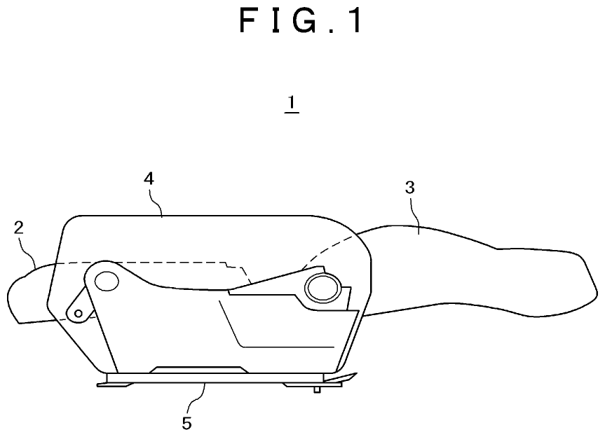

FIG. 1 is a side view illustrating a configuration of a vehicle seat according to the first embodiment. FIG. 1 illustrates the vehicle seat in a full-flat state.

The vehicle seat 1 includes a seat cushion 2 and a seat back 3 mounted to be tiltable with respect to the rear end portion of the seat cushion 2. Shield covers 4 to cover a pair of right and left respective risers (6) described later are disposed on right and left side surfaces of the vehicle seat 1. The shield covers 4 can be each made of a resin and are also usable as, for example, arm rests.

A pair of right and left tracks 5 are disposed at the lower portions of the respective risers (6) covered with the respective shield covers 4. The tracks 5 have a role as slide mechanisms that allow the vehicle seat 1 to move in a front-rear direction. The tracks 5 each include a lower rail fixed to a floor of the vehicle and an upper rail that can move on the lower rail in the front-rear direction. The risers (6) of the vehicle seat 1 are each fixed to the upper rail.

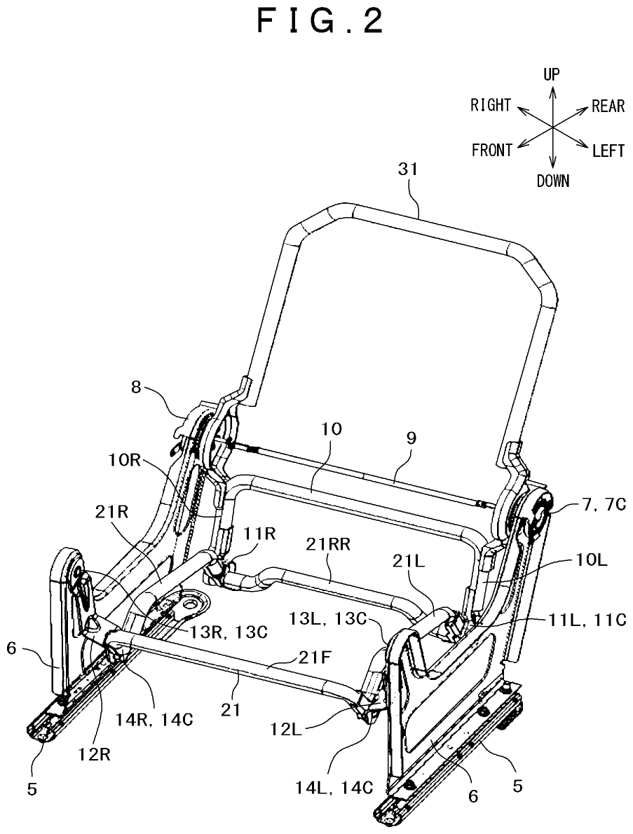

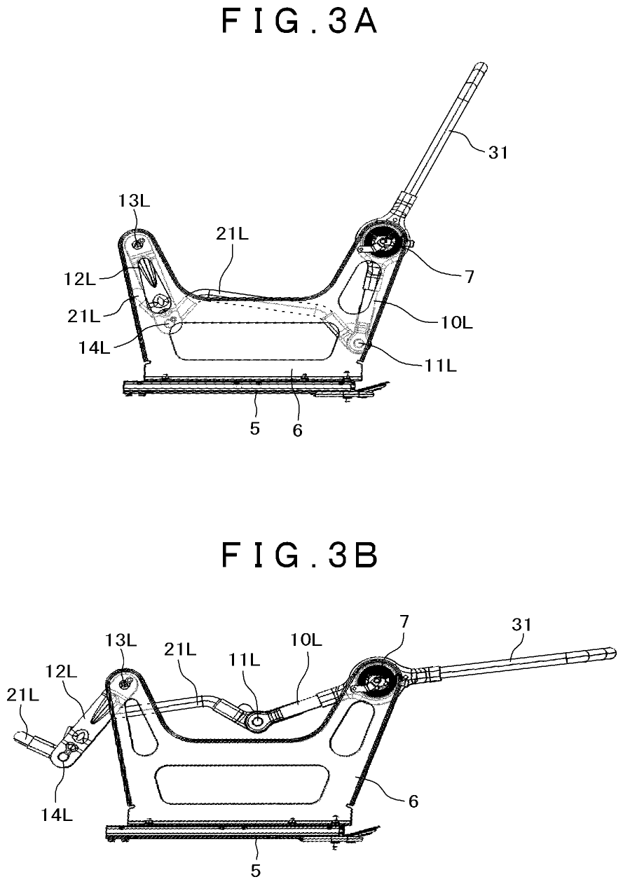

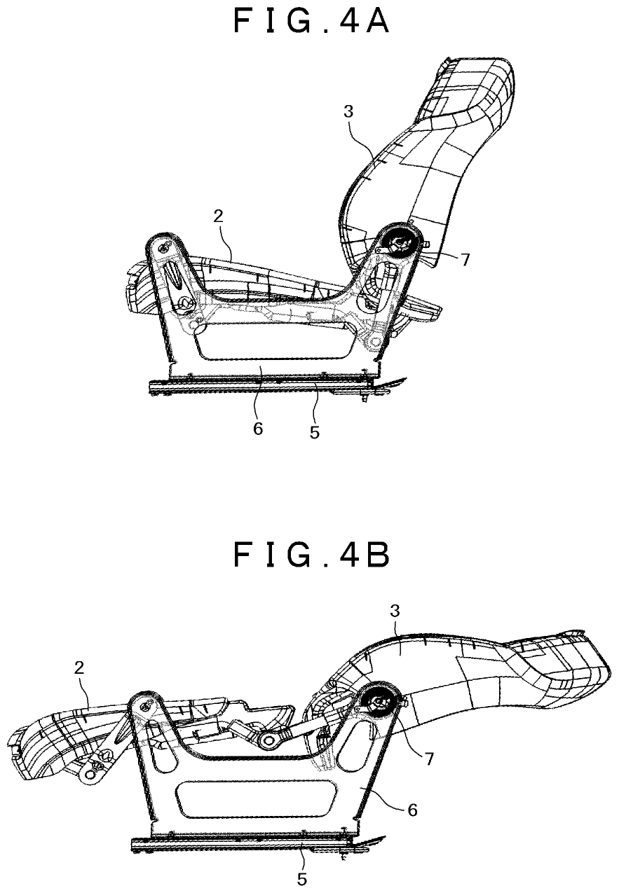

FIG. 2 is a front perspective view illustrating a frame structure of the vehicle seat 1 of FIG. 1. FIG. 2 corresponds to a state where seat skins and cushion materials of the seat cushion 2 and the seat back 3 are removed from the vehicle seat 1 of FIG. 1 and the shield covers 4 are removed. FIG. 3A and FIG. 3B are left side views of the frame structure of the vehicle seat of FIG. 2, FIG. 3A is a drawing illustrating a usual use state, and FIG. 3B is a drawing illustrating a state close to a full-flat state. FIG. 4A and FIG. 4B are left side views when the seat skin and the cushion material are attached to the frame structure of FIG. 3A and FIG. 3B, FIG. 4A is a drawing illustrating the usual use state, and FIG. 4B is a drawing illustrating the state close to the full-flat state.

With reference to FIG. 2, a back frame 31 of the seat back 3 is formed of a rounded pipe member bent into an approximately U shape. The left end portion of the back frame 31 is coupled to a reclining mechanism 7. The right end portion of the back frame 31 is coupled to a reclining lock mechanism 8. The reclining mechanism 7 and the reclining lock mechanism 8 are coupled with a coupling shaft 9.

The reclining mechanism 7 is disposed at the upper end portion at the rear of the left riser 6. The reclining lock mechanism 8 is disposed at the upper end portion at the rear of the right riser 6.

A cushion frame 21 of the seat cushion 2 is formed of a rounded pipe member bent into an approximately rectangular shape. The cushion frame 21 includes a front frame 21F, a rear frame 21RR, a left frame 21L, and a right frame 21R.

A first link member 10 is disposed to couple between the back frame 31 and the rear portion of the cushion frame 21. The first link member 10 is formed of a rounded pipe member bent into an approximately U shape. The first link member 10 includes a left link portion 10L and a right link portion 10R. The upper end portion of the left link part 10L is coupled to the reclining mechanism 7. The lower end portion of the left link part 10L is rotatably coupled to the left end portion of the rear frame 21RR via a first pivot 11L. The upper end portion of the right link portion 10R is coupled to the reclining lock mechanism 8. The lower end portion of the right link portion 10R is rotatably coupled to the right end portion of the rear frame 21RR via a first pivot 11R.

With the above-described configuration, the rear frame 21RR of the cushion frame 21 moves on a circular moving trajectory with a rotational center 7C of the reclining mechanism 7 as a center point and with a distance between the rotational center 7C of the reclining mechanism 7 and a rotational center 11C of the first pivot (11R, 11L) as a radius. Accordingly, when the seat back 3 is inclined rearward, the rear end portion of the seat cushion 2 moves forward and upward in conjunction with the inclination.

A second link member 12 (12L, 12R) is disposed on the front frame 21F side of the cushion frame 21.

The upper end portion of the left link member 12L of the second link member 12 is rotatably coupled to the upper end portion at the front of the left riser 6 via a second pivot 13L. The lower end portion of the left link member 12L is rotatably coupled to the left end portion of the front frame 21F via a third pivot 14L.

The upper end portion of the right link member 12R of the second link member 12 is rotatably coupled to the upper end portion at the front of the right riser 6 via a second pivot 13R. The lower end portion of the right link member 12R is rotatably coupled to the right end portion of the front frame 21F via a third pivot 14R.

With the above-described configuration, the front frame 21F of the cushion frame 21 moves on a circular moving trajectory with a rotational center 13C of the second pivot (13R, 13L) as a center point and with a distance between the rotational center 13C of the second pivot (13R, 13L) and a rotational center 14C of the third pivot (14R, 14L) as a radius. Accordingly, when the seat back 3 is inclined rearward, the front end portion of the seat cushion 2 moves forward and upward in conjunction with the inclination.

Accordingly, with the first link member 10 and the second link member 12, when the seat back 3 is inclined rearward, the entire seat cushion 2 moves forward and upward in conjunction with the inclination.

The following mainly describes states of the first pivot 11L, the second pivot 13L, the third pivot 14L, the seat cushion 2, and the seat back 3 with reference to FIG. 3A, FIG. 3B, FIG. 4A, and FIG. 4B. Although FIG. 3A, FIG. 3B, FIG. 4A, and FIG. 4B illustrate the state when the vehicle seat 1 is viewed from the left side, the same applies to the case where the vehicle seat 1 is viewed from the right side; therefore, the following omits the description in the case of the right side.

As illustrated in FIG. 3A, in the usual use state, that is, in the state where the back frame 31 (or the seat back 3) is stood, the first pivot 11L is positioned at the almost lower side of the reclining mechanism 7. The third pivot 14L is positioned at the almost lower side of the second pivot 13L. In this state, as illustrated in FIG. 4A, the rear end portion of the seat cushion 2 is positioned on the lower side of the lower end portion of the seat back 3.

Meanwhile, as illustrated in FIG. 3B, in the state close to the full-flat state, that is, in the state where the back frame 31 (or the seat back 3) is inclined rearward, the first pivot 11L moves to a position on an obliquely lower left side with respect to the reclining mechanism 7. That is, the first pivot 11L moves in an upper left direction compared with the state illustrated in FIG. 3A. The third pivot 14L moves to a position at a lower right side in front of the second pivot 13L. That is, the third pivot 14L moves to the upper left direction compared with the state illustrated in FIG. 3A. Setting the back frame 31 in the full-flat state (for example, inclined rearward up to a position in the horizontal state) moves the positions of the first pivot 11L and the third pivot 14L in the upper left direction with respect to the position illustrated in FIG. 3B. In this state, as illustrated in FIG. 4B, the rear end portion of the seat cushion 2 is positioned on the left side of the lower end portion of the seat back 3.

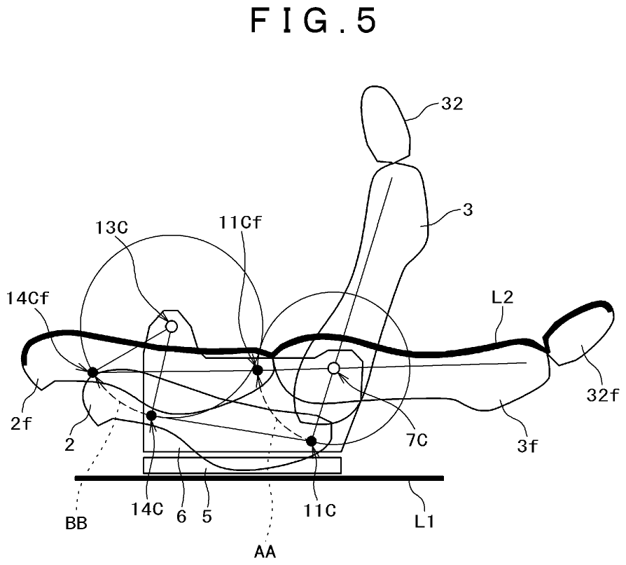

FIG. 5 is a drawing describing the usual use state and the full-flat state of the vehicle seat. FIG. 5 also illustrates a headrest 32, which is disposed at the upper end portion of the seat back 3.

In FIG. 5, reference numerals to which “f” is added to the ends of the reference numerals indicate respective units when the vehicle seat 1 is set in the full-flat state. For example, the seat cushion 2, the seat back 3, and the headrest 32 indicate the respective units in the usual use state. On the other hand, a seat cushion 2f, a seat back 3f, and a headrest 32f indicate respective units in the full-flat state. In FIG. 5, a line L1 indicates a floor surface of the vehicle to which the lower rails of the tracks 5 are fixed, and a line L2 is a line indicative of respective surfaces of the seat cushion 2f, the seat back 3f, and the headrest 32f when the vehicle seat 1 is in the full-flat state.

As illustrated in FIG. 5, when the vehicle seat 1 is set in the full-flat state, the rotational center 11C of the first pivot (11R, 11L) in the usual use state moves on a circular moving trajectory with the rotational center 7C of the reclining mechanism 7 as a center point and with a distance between the rotational center 7C of the reclining mechanism 7 and the rotational center 11C of the first pivot (11R, 11L) as a radius as indicated by an arrow AA, thus moving to a position indicated by a rotational center 11Cf. That is, the rotational center 11C of the first pivot (11R, 11L) in the usual use state is positioned at the lower side of the rotational center 7C of the reclining mechanism 7. When the vehicle seat 1 is set to the full-flat state, the rotational center 11C moves from the lower side of the rotational center 7C as indicated by the arrow AA and then is positioned as the rotational center 11Cf, the lateral side of the rotational center 7C.

When the vehicle seat 1 is set in the full-flat state, the rotational center 14C of the third pivot (14R, 14L) in the usual use state moves on a circular moving trajectory with the rotational center 13C of the second pivot (13R, 13L) as a center point and with a distance between the rotational center 13C of the second pivot (13R, 13L) and the rotational center 14C of the third pivot (14R, 14L) as a radius as indicated by an arrow BB, thus moving to a position indicated by a rotational center 14Cf. That is, the rotational center 14C of the third pivot (14R, 14L) in the usual use state is positioned at the lower side of the rotational center 13C of the second pivot (13R, 13L). When the vehicle seat 1 is set in the full-flat state, the rotational center 14C moves from the lower side of the rotational center 13C as indicated by the arrow BB and then is positioned as the rotational center 14Cf, the left lower side of the rotational center 13C.

Accordingly, the rear end portion and the front end portion of the seat cushion 2 comparatively easily move to the upper side using the rotational center 7C and the rotational center 13C as fulcrums in conjunction with the rear inclination of the seat back 3. That is, as illustrated in FIG. 3A and FIG. 3B, the rear end portion and the front end portion of the seat cushion 2 move in conjunction with the rear inclination of the seat back 3 with the left link part 10L and the right link portion 10R. Thus, this embodiment can set the vehicle seat 1 in the full-flat state with the comparatively simple configuration without using a complicated configuration such as a gear. Since the configuration of the vehicle seat 1 itself is simple, the vehicle seat 1 is excellent in robustness and less likely to be broken. Additionally, the vehicle seat 1 features, for example, reduced backlash and abnormal noise in use.

With the first embodiment, the following effects can be obtained.

1) The line L2 indicative of the respective surfaces of the seat cushion 2f, the seat back 3f, and the headrest 32f when the vehicle seat 1 is set in the full-flat state becomes approximately parallel to the floor surface (line L1) of the vehicle to which the tracks 5 are fixed. This allows providing a flat, full reclining posture approximately parallel to the floor surface (line L1) of the vehicle.

For example, in the case where a rear obstacle such as a rear seat is present on the rear side of the vehicle seat 1, adjusting a height position of the rotational center 7C of the reclining mechanism 7 from the floor surface (line L1) of the vehicle allows providing the flat, full reclining posture while avoiding the rear obstacle.

2) The coordinated movement of the seat back 3 and the seat cushion 2 in the full-flat state is similar to usability of the usual reclining mechanism, and the operation in the full-flat state is simple.

3) The rotational center 11C of the first pivot (11R, 11L) is configured to be near the center of the circular arc cross-sectional shape at the rear end portion of the seat cushion 2. This ensues facilitating regulating a clearance between the lower end portion of the seat back 3 and the rear end portion of the seat cushion 2 and a sliding resistance between the lower end portion of the seat back 3 and the rear end portion of the seat cushion 2 during reclining.

### Second Embodiment

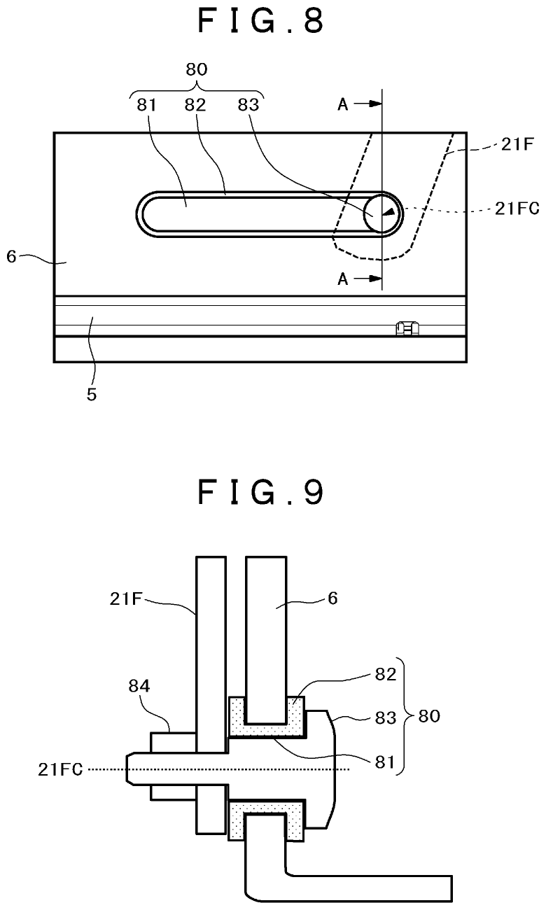

The following describes a vehicle seat of the second embodiment. The vehicle seat 1 of the first embodiment has the configuration that includes the first link member 10 (10L, 10R) coupled to the rear frame 21RR of the cushion frame 21 and the second link member 12 (12L, 12R) coupled to the front frame 21F side of the cushion frame 21. The vehicle seat of the second embodiment includes a slide mechanism (80) for parallel movement of the front frame 21F on the front frame 21F side of the cushion frame 21. The slide mechanism (80) will be described in detail in FIG. 8 and FIG. 9.

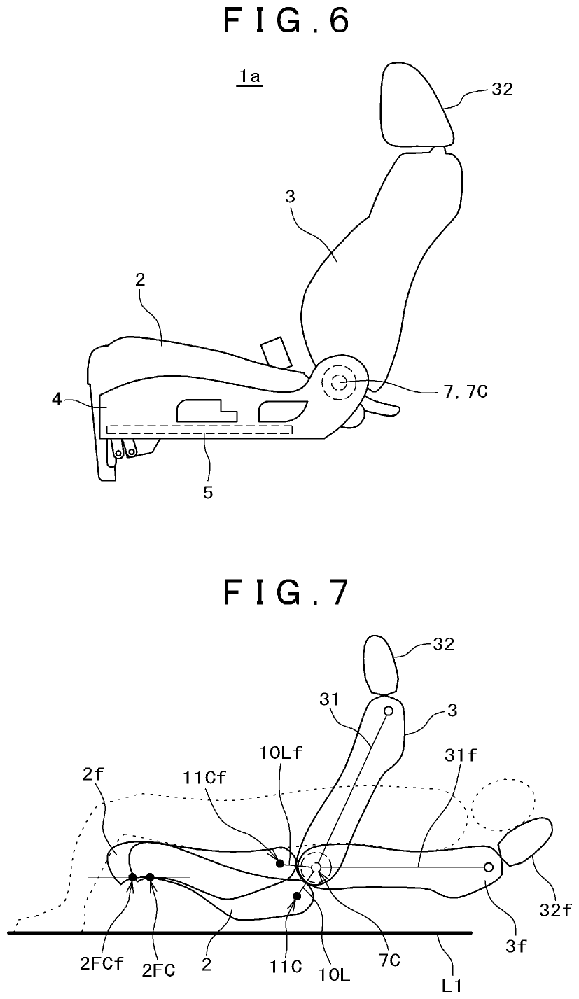

FIG. 6 is a side view illustrating the configuration of the vehicle seat according to the second embodiment.

A vehicle seat 1a includes the seat cushion 2, the seat back 3 mounted to be tiltable with respect to the rear end portion of the seat cushion 2, and the headrest 32 disposed on the upper end portion of the seat back 3. The shield covers 4 to cover the pair of right and left respective risers (6) described later are disposed on the right and left side surfaces of the vehicle seat 1a. The shield covers 4 can be each made of a resin.

The pair of right and left tracks 5 are disposed at the lower portions of the respective risers (6) covered with the respective shield covers 4. The tracks 5 have a role as slide mechanisms that allow the vehicle seat 1a to move in the front-rear direction. The tracks 5 each include the lower rail fixed to the floor of the vehicle and the upper rail that can move on the lower rail in the front-rear direction. The risers (6) of the vehicle seat 1a are each fixed to the upper rail.

The reclining mechanism 7 tiltably couples the rear end portion of the seat cushion 2 to the lower end of the seat back 3. That is, similarly to the first embodiment, the rear end portion of the seat frame of the seat cushion 2 and the lower end of the back frame 31 of the seat back 3 are, for example, linked with the first link member 10 (10L, 10R) and are tiltable with the reclining mechanism 7. Note that the first link member 10 has a length shorter than that of the first link member 10 of the first embodiment.

FIG. 7 is a drawing describing the usual use state and the full-flat state of the vehicle seat according to the second embodiment. In FIG. 7, reference numerals to which “f” is added to the ends of the reference numerals indicate respective units when the vehicle seat 1a is set in the full-flat state. For example, the seat cushion 2, the seat back 3, and the headrest 32 indicate the respective units in the usual use state. On the other hand, the seat cushion 2f, the seat back 3f, and the headrest 32f indicate the respective units in the full-flat state. In FIG. 7, the line L1 indicates a floor surface of the vehicle to which the tracks 5 are fixed.

As illustrated in FIG. 7, when the vehicle seat 1a is set in the full-flat state, the rotational center 11C of the first pivot (11R, 11L) in the usual use state moves on a circular moving trajectory with the rotational center 7C of the reclining mechanism 7 as a center point and with a distance between the rotational center 7C of the reclining mechanism 7 and the rotational center 11C of the first pivot (11R, 11L) as a radius, thus moving to a position indicated by the rotational center 11Cf.

On the other hand, with the vehicle seat 1a in the full-flat state, a rotational center 21FC of the front frame 21F of the cushion frame of the vehicle seat 1a moves parallel to a position indicated by a rotational center 21FCf by the slide mechanism (80).

FIG. 8 is a side view illustrating the slide mechanism 80. FIG. 9 is a cross-sectional view taken along a line A-A in FIG. 8. FIG. 8 illustrates a state where the shield covers 4 are removed in FIG. 6 and illustrates the left riser 6 fixed to a track 5 and the slide mechanism 80 disposed at the left riser 6.

With reference to FIG. 8 and FIG. 9, the slide mechanism 80 includes a slide groove 81 disposed parallel to the track 5, a bush 82, which is a bearing member made of resin disposed so as to cover the peripheral portion of the slide groove 81, and a sliding pivot 83 embedded into the bush 82. The sliding pivot 83 is rotatably or movably fixed to the front frame 21F of the cushion frame. The rotational center 21FC of the front frame 21F of the cushion frame is movable inside the bush 82 parallel to and along the slide groove 81. The distal end side of the sliding pivot 83 penetrates an opening disposed on the front frame 21F of the cushion frame and is fixed to a nut 84 by, for example, welding.

Similarly to the first embodiment, with the above-described configuration according to the second embodiment, the respective surfaces of the seat cushion 2f, the seat back 3f, and the headrest 32f when the vehicle seat 1a is set in the full-flat state become approximately parallel to the floor surface (line L1) of the vehicle to which the tracks 5 are fixed.

With the second embodiment, the following effects can be obtained.

The vehicle seat 1a of the second embodiment in the full-flat state slides the front end portion of the seat cushion 2f forward by the slide mechanism 80. Therefore, the heights of the respective surfaces of the seat cushion 2f, the seat back 3f, and the headrest 32f of the vehicle seat 1a in the full-flat state can be lower than those of the vehicle seat 1 of the first embodiment. That is, while the full-flat state can be set, the vehicle seat 1a with the low-profile seat cushion 2f can be provided.

While the invention made by the inventor has been specifically described based on the embodiments, this invention is not limited to the above-described embodiments, and obviously, variously changeable.

### REFERENCE SIGNS LIST

1: vehicle seat
2: seat cushion
3: seat back
4: shield cover
5: track
6: riser
7: reclining mechanism
8: reclining lock mechanism
9: coupling shaft
10, 10L, 10R: first link member
11, 11L, 11R: first pivot
12, 12L, 12R: second link member
13L, 13R: second pivot
14L, 14R: third pivot
21: cushion frame
21F: front frame
21L: left frame
21R: right frame
31: back frame
80: slide mechanism
81: slide groove
82: bush (bearing member)
83: sliding pivot

What is claimed is:

1. A vehicle seat comprising:
a seat cushion that includes a cushion frame;
a seat back that includes a back frame;
risers;
a reclining mechanism disposed at an upper portion at a rear end of the riser, the reclining mechanism being coupled to a lower end portion of the back frame;
a first link member rotatably disposed between a rear end portion of the cushion frame and the reclining mechanism;
a second link member rotatably disposed between upper portions at front ends of the risers and front end portions of the cushion frame; and
tracks disposed at lower portions of the risers,
wherein in conjunction with a rear inclination of the seat cushion by the reclining mechanism, a rear end portion of the seat cushion moves forward and upward by the first link member, and a front end portion of the seat cushion moves forward and upward by the second link member.

2. The vehicle seat according to claim 1,
wherein when the seat cushion is fully reclined by the reclining mechanism, a top surface of the seat cushion and a top surface of the seat back are approximately horizontal to a floor surface of a vehicle to which the tracks are installed.

3. The vehicle seat according to claim 1,
wherein when the seat cushion and the seat back are set in a usual use state by the reclining mechanism:
a rotational center of the rear end portion of the cushion frame and the first link member is positioned between a rotational center of the reclining mechanism and the track; and
a rotational center of the front end portion of the cushion frame and the second link member is positioned between a rotational center of an upper portion at a front end of the riser with the second link member and the track.

4. The vehicle seat according to claim 3,
wherein the rotational center of the rear end portion of the cushion frame and the first link member is positioned near a center of a circular arc cross-sectional shape at the rear end portion of the seat cushion.

5. A vehicle seat comprising:
a seat cushion that includes a cushion frame;
a seat back that includes a back frame;
risers;
a reclining mechanism disposed at a rear end of the riser, the reclining mechanism being coupled to a lower end portion of the back frame;
a link member rotatably disposed between a rear end portion of the cushion frame and the reclining mechanism;
a slide mechanism disposed at the riser, the slide mechanism being configured to slide a front end portion of the cushion frame; and
tracks disposed at lower portions of the risers,
wherein the sliding by the slide mechanism is approximately horizontal to the tracks.

6. The vehicle seat according to claim 5,
wherein the slide mechanism includes:
a slide groove disposed at the riser;
a bearing member disposed so as to cover a peripheral portion of the slide groove; and
a sliding pivot embedded into the bearing member.
